(19) United States
(12) Patent Application Publication
(10) Pub. No.: US 2012/0304938 A1
(43) Pub. Date: Dec. 6, 2012

(54) GROOMING TOOL AND METHOD FOR THE MANUFACTURE OF A GROOMING TOOL

(75) Inventor: Yueh Yu Wang, Kwun Tong (HK)

(73) Assignee: TOPET INTERNATIONAL CO., LIMITED, Kwun Tong (HK)

(21) Appl. No.: 13/150,943

(22) Filed: Jun. 1, 2011

(51) Int. Cl. A01K 13/00; B23P 17/04

(52) U.S. Cl. 119/618; 29/428

(57) ABSTRACT

A grooming tool that includes a de-shedding rake and a method for assembling the de-shedding rake and the grooming tool. The grooming tool includes a handle portion, and the de-shedding rake is operatively attached to the handle portion. The de-shedding rake includes an axle, a spacer block disposed along the axle and having a plurality of spaced-apart slots and a plurality of de-shedding blades disposed along the axle and within the spaced-apart slots. The use of a spacer block to separate the de-shedding blades significantly reduces the assembly time and cost associated with manufacturing the grooming tool. The invention also includes a method for assembling the de-shedding rake and the grooming tool. The grooming tool is particularly useful for the grooming of furred animals such as dogs and cats.

### FIELD OF THE INVENTION

This invention relates to the field of grooming tools, such as for grooming furred animals. In particular, the invention relates to a grooming tool including a de-shedding rake and a method for the manufacture of a grooming tool having a de-shedding rake that includes a plurality of spaced-apart de-shedding blades.

### BACKGROUND OF THE INVENTION

Grooming an animal is important to the animal's health and appearance. Grooming can also provide enjoyment to the groomer, which in many cases is the owner of the animal. Grooming may also allow for emotional bonding between the animal and groomer. Accordingly, there exists a need for products and apparatus in order to assist an owner or groomer in the grooming of an animal.

Some animals, such as dogs, have a coat of fur that includes an undercoat and a topcoat. Generally, the topcoat includes rough, somewhat weather resistant fur that functions to repel water, wind, and other dirt or debris. The undercoat usually comprises thick, warm, down-like fur made up of generally shorter hairs than those of the topcoat. The undercoat fur is usually dense enough to resist penetration of water to the skin of the animal and provides an insulating layer to assist in keeping the animal warm. As such, many animals, and particularly dogs, seasonally grow a dense undercoat. In turn, the undercoat is also seasonally shed.

Shedding occurs because each follicle of hair in an animal's coat follows a cycle of growing, dying, and being replaced by another follicle. When the follicle dies, the hair becomes detached, or shed. This shedding process may occur constantly. The rate at which fur is shed may be affected by such factors as the breed, age and environment of the animal. For instance, as stated above, the undercoat of the animal may change seasonally, such that in cooler months of the year the undercoat grows denser in order to provide insulation. Accordingly, during warmer months, a portion of the undercoat may be shed.

While shedding of the undercoat occurs naturally, it may be advantageous to assist in the removal of the undercoat by grooming the animal. For instance, if a dog is kept indoors, the owner may wish to assist or accelerate the shedding process by brushing or combing the fur of the dog in order to remove loose fur or fur that will soon be shed, a process referred to as de-shedding. The de-shedding of a dog to remove the undercoat may be conducted in a location determined by the owner. The location of de-shedding may be controlled such that the de-shedding process is conducted to prevent continuous shedding within the owner's home or other location where shedding might be undesirable. Shedding can thus be controlled such that the owner may be able to selectively de-shed the dog in order to prevent the undercoat from being shed indoors.

De-shedding an animal presents several advantages versus allowing natural shedding. For many individuals, loose fur of the animal may be an allergen such that limiting the amount of fur shed indoors may prevent unwanted allergy symptoms. Further, shed fur may cling to upholstery or clothing and may require much time and effort to remove the fur from such surfaces.

Additionally, assisting in the normal process of shedding through de-shedding may benefit the health and comfort of the animal. An excessive amount of residual undercoat may cause the animal to endure heat stress more readily due to the insulating properties of the undercoat. Moreover, undercoat removal may prevent the animal's fur from becoming tangled or matted. Such grooming may also calm or relax the animal.

As a result, there are a variety of grooming tools available that include a de-shedding rake to address the foregoing desires and concerns. One type of available grooming tool includes a stripping knife disposed at the end of a handle. See, for example, U.S. Pat. No. 6,782,846 by Porter et al. Such devices include a unitary toothed rake, similar to the blade used in electric grooming shears that includes a relatively sharp blade edge with a plurality of short, comb-like teeth extending from the sharp edge.

Another type of grooming tool includes a de-shedding rake having a plurality of flat de-shedding blades that are disposed along an axle in parallel, spaced-apart relation. An example of this type of grooming tool is the SHEDZILLA grooming tool available from Sunbeam Products, Inc. (d/b/a Jarden Consumer Solutions) of Boca Raton, Florida. Another grooming tool of this type is the COAT KING grooming tool available from Mars Pet Grooming Products, Burpengary, Queensland, Australia.

### SUMMARY OF THE INVENTION

Grooming tools including de-shedding rakes having a plurality of flat de-shedding blades offer many advantages over other types of de-shedding rakes. However, the cost of this type of grooming tool is heavily influenced by the labor time that is required to manually assemble the de-shedding rake. It is therefore an object to provide an improved grooming tool that requires significantly less assembly time and therefore reduces the cost of the grooming tool.

It would be advantageous to provide a grooming tool that may be assembled in a relatively rapid manner, thereby reducing the cost of the tool. Accordingly, one embodiment disclosed herein is directed to a grooming tool that includes a handle that is adapted to be gripped by a user and a de-shedding rake that is attached to the handle. The de-shedding rake includes an axle having a longitudinal axis and a spacer block disposed along the axle that includes a plurality of spacer tabs defining spaced-apart slots along a length of the spacer block. A plurality of de-shedding blades is operatively disposed along the axle with each de-shedding blade being placed within a spaced-apart slot. Such a construction significantly reduces the assembly time required for the de-shedding rake by eliminating the need for individual washers to be placed between adjacent de-shedding blades.

Also disclosed herein are optional variations and refinements of the foregoing embodiment. For example, in one aspect, the grooming tool may also include a bracket that operatively attaches the de-shedding rake to the handle. The bracket may be attached to the handle with a mechanical fastener, for example. The bracket may include a proximal end that is affixed to the handle and two mounting arms extending from the proximal end. In this regard, the spacer block and the plurality of de-shedding blades may be mounted between the two mounting arms that extend away from the proximal end.

In another aspect, a cross-section of the axle that is orthogonal to the longitudinal axis may be non-circular, such as rectangular. In this manner, the de-shedding blades that are disposed along the axle may be rigid and fixed (e.g., unable to rotate about the longitudinal axis of the axle). For example, the cross-section of the axle orthogonal to the longitudinal axis may be substantially rectangular in cross-section.

In another aspect, the de-shedding blades may comprise a substantially planar body that is mounted substantially orthogonally to the longitudinal axis of the axle. The substantially planar body may comprise a bottom edge and a fur-engaging member (e.g., a hooked fur-engaging member) extending from the bottom edge. The substantially planar body may further comprise a sharpened curvilinear portion between the bottom edge and the hooked fur-engaging member. The de-shedding blades may be fabricated from a corrosion-resistant metal, such as stainless steel.

In another aspect, the spacer block may comprise a plastic material. Plastic materials (e.g., thermoplastics) provide a reduced cost and ease of moldability. In another aspect, the spacer block may comprise a first spacer block portion comprising first spacer tabs and a second spacer block portion comprising second spacer tabs, where the first and second portions are fastened together such that the first spacer tabs are disposed between the second spacer tabs. The use of first and second spacer block portions may advantageously facilitate the molding process.

In another aspect, a locking nut may be threaded onto at least one end of the axle to secure the de-shedding blades and the spacer block onto the axle. For example, the locking nut may compress the de-shedding blades and the spacer tabs together to restrict movement of the de-shedding blades.

In another aspect, the de-shedding rake may comprise at least about 4 de-shedding blades per cm along the longitudinal axis of the axle, such as at least about 5 de-shedding blades per cm. The spacing between adjacent de-shedding blades may be at least about 0.75 mm and not greater than about 5 mm, such as at least about 1 mm and not greater than about 3 mm. As such, the thickness of the spacer tabs may be at least about 0.75 mm and not greater than about 5 mm, such as at least about 1 mm and not greater than about 3 mm.

According to another embodiment, a grooming tool is provided that includes a handle, a de-shedding rake, and a bracket attaching the deshedding rake to the handle.

The handle includes a gripping portion that is adapted to be gripped by a user. The de-shedding rake includes an axle, a plastic spacer block, a plurality of de-shedding blades and at least a first locking nut. The axle has a longitudinal axis wherein a cross-section of the axle orthogonal to the longitudinal axis is non-circular. The plastic spacer block is disposed along the axle and comprises a plurality of spacer tabs defining spaced-apart slots along a length of the spacer block. The de-shedding blades are operatively disposed along the axle and within the spaced-apart slots, and the locking nut is threaded onto an end of the axle to secure the de-shedding blades and the spacer block onto the axle and compress the de-shedding blades and the spacer tabs together.

The bracket operatively attaches the de-shedding rake to the handle. In this regard, the bracket includes a proximal end that is affixed to the handle and two mounting arms extending from the proximal end, wherein the de-shedding blades and plastic spacer block are disposed between the two mounting arms of the bracket.

Methods for the assembly of a de-shedding rake and a grooming tool are also disclosed herein. In one embodiment, the method for assembling a de-shedding rake comprises the steps of placing a plurality of de-shedding blades within spaced-apart slots defined by a plurality of spacer tabs of a plastic spacer block, inserting an axle having a longitudinal axis through mounting apertures disposed in the de-shedding blades and through spacer block apertures disposed in the spacer tabs, and securing the de-shedding blades and the spacer block onto the axle by compressing the de-shedding blades and the spacer tabs together to restrict movement of the de-shedding blades along the longitudinal axis.

In one aspect, the method for assembling the de-shedding rake may include the step of assembling the plastic spacer block by fastening together a first spacer block portion having first spacer tabs and a second spacer block portion having second spacer tabs such that the first spacer tabs are disposed between the second spacer tabs. In another aspect, the method may further include the step of attaching the axle to spaced-apart mounting arms of a bracket.

A method for assembling a grooming tool is also disclosed. The method includes assembling a de-shedding rake such as in the manner discussed above, and attaching the de-shedding rake to a handle that is adapted to be gripped by a user.

The present invention is directed to the embodiments and aspects that are summarized above, alone or in any combination, as well as additional embodiments and aspects and combinations thereof that will be apparent from the following description of the invention. However, the foregoing summary is intended to provide a basic understanding of at least some embodiments and aspects of the invention. This summary is not an extensive overview of the invention. It is not intended to identify key or critical elements of the invention or to delineate the scope of the invention. The foregoing summary merely presents some concepts of the invention in general form as a prelude to a more detailed description provided below.

### DESCRIPTION OF THE DRAWINGS

FIG. 1 illustrates a perspective view of a prior art grooming tool including a de-shedding rake.

FIG. 2 illustrates an exploded view of a prior art grooming tool including a de-shedding rake.

FIG. 3 illustrates a perspective end view of a grooming tool including a de-shedding rake in accordance with an embodiment of the invention.

FIG. 4 illustrates a bottom view of a grooming tool including a de-shedding rake in accordance with an embodiment of the invention.

FIG. 5 illustrates a side view of a de-shedding blade that is useful in a de-shedding rake in accordance with an embodiment of the invention.

FIGS. 6a-6c illustrate a perspective view of a spacer block that is useful for a de-shedding rake in accordance with an embodiment of the invention.

FIG. 7 illustrates an exploded view of a grooming tool including a de-shedding rake in accordance with an embodiment of the invention.

FIG. 8 is a flow sheet illustrating a method for manufacturing a de-shedding rake and grooming tool in accordance with an embodiment of the invention.

### DESCRIPTION OF THE INVENTION

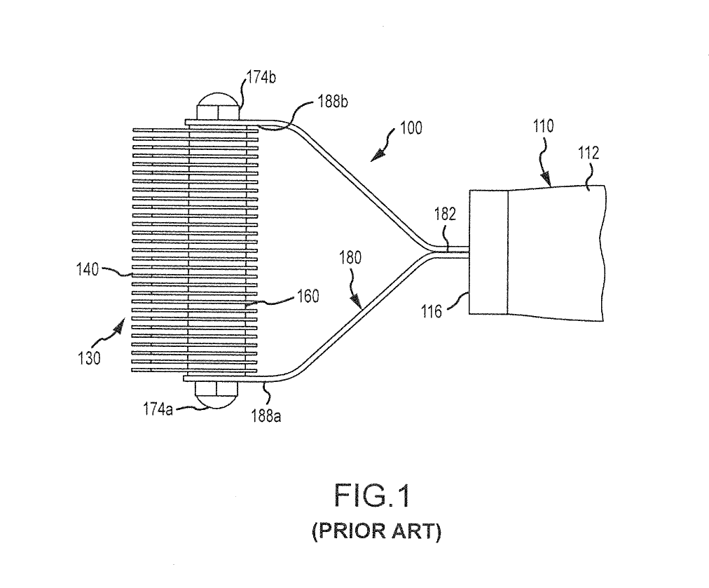

FIG. 1 illustrates a perspective view of a prior art grooming tool 100 that is of similar construction to a COAT KING grooming tool available from Mars Pet Grooming Products, Burpengary, Queensland, Australia. The grooming tool 100 includes a handle 110 and a de-shedding rake 130 operatively attached to the handle 110 using a bracket 180. The bracket 180 includes a proximal end 182 that is affixed to a distal end 116 of a gripping portion 112 of the handle 110, and the bracket 180 includes two mounting arms 188a and 188b extending away from the proximal end 182. The de-shedding rake 130 is attached to the mounting arms 188a and 188b of the bracket 180 to operatively attach the de-shedding rake 130 to the handle 110.

The de-shedding rake 130 includes a plurality of substantially flat de-shedding blades 140 that are operatively disposed in spaced-apart and parallel relation along an axle (not visible in FIG. 1), i.e., where the axle extends though apertures in the de-shedding blades 140. In this manner, a user can grip the gripping portion 112 of the handle 110 and drag the de-shedding blades 140 across an animal's fur. To maintain proper spacing between adjacent de-shedding blades 140, a plurality of individual washers 160 are also disposed on the axle between the individual de-shedding blades 140, i.e., with one washer 160 placed between each adjacent pair of de-shedding blades 140, and one washer 160 between each mounting arm 188a and 188b and the first and last de-shedding blades 140 along the axle. The de-shedding blades 140 and washers 160 may be secured to the bracket 180 using one or more locking nuts 174a and 174b.

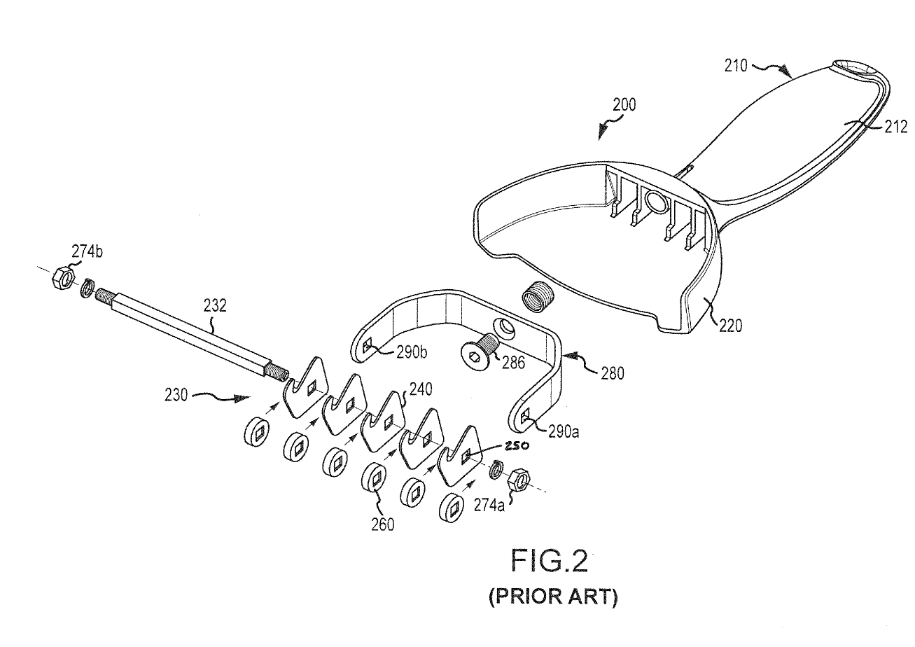

FIG. 2 illustrates an exploded view of a prior art grooming tool 200 that is of similar construction to the SHEDZILLA grooming tool available from Sunbeam Products, Inc. (d/b/a Jarden Consumer Solutions) of Boca Raton, Florida. The grooming tool 200 includes a handle 210 having a gripping portion 212 and a hood 220 for aesthetic purposes. A bracket 280 is attached to the handle using a mechanical fastener 286. A de-shedding rake 230 is attached to the bracket 280 through axle end apertures 290a and 290b in the bracket 280.

The de-shedding rake 230 includes a plurality of de-shedding blades 240 that are disposed on the axle 232 by placing the axle through mounting apertures 250 in each of the de-shedding blades 240. To maintain proper spacing between de-shedding blades, a plurality of washers 260 are manually placed onto the axle 232 in alternating relationship with the de-shedding blades 240. The non-circular cross section of the axle 232 ensures that the de-shedding blades 240 are properly aligned, and the washers ensure that the shedding blades 240 are evenly spaced along the axle 232. The washers 260 are typically fabricated from a non-corrosive metal such as stainless steel or a coated metal such as chrome-plated copper.

After manual placement of the individual washers 260 and de-shedding blades 240 onto the axle 232, the axle 232 may be placed through the axle aperture 290a of the bracket 280, and locking nuts 274a and 274b may be placed at each end of the axle 232 to secure the axle to the bracket 280.

Thus, to assemble the de-shedding rake 230, the plurality of individual de-shedding blades 240 and individual washers 260 must be manually placed onto the axle 232 in alternating fashion, typically when a first end of the axle 232 is already inserted through an aperture of the bracket 280, such as aperture 290b. Although for purposes of illustration, the de-shedding rake illustrated in FIG. 2 has only 5 de-shedding blades 240, such de-shedding rakes typically include over 10 de-shedding blades and commonly include at least 25 de-shedding blades or more. Thus, the manual assembly process requiring alternate placement of de-shedding blades 240 and washers 260 and is tedious and time-consuming, significantly increasing the cost to assemble the de-shedding rake 230 and the grooming tool 200.

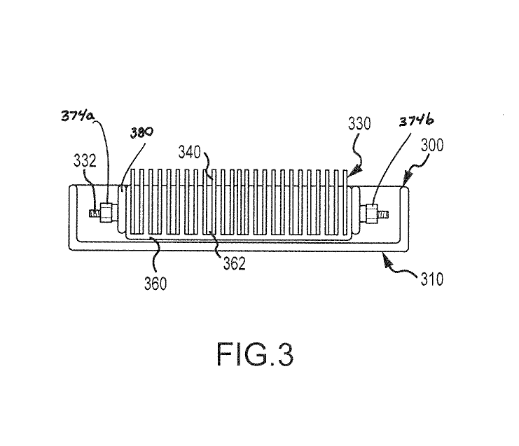

FIG. 3 illustrates an end view of a grooming tool 300 according to an embodiment of the invention. The grooming tool 300 includes a handle 310 and a de-shedding rake 330 that is operatively attached to the handle 310 using a bracket 380. The de-shedding rake 330 includes an axle 332 and a plurality of de-shedding blades 340 operatively disposed along the axle 332. The de-shedding blades 340 are disposed within a spacer block 360, where the spacer block 360 includes a plurality of spacer tabs 362. That is, the de-shedding blades 340 are inserted between the spacer tabs 362 to evenly space the de-shedding blades 340 along the axle 332. During assembly of the de-shedding rake 330, the de-shedding blades 340 are placed between the spacer tabs 362 of the spacer block 360 and the axle 332 may then be inserted through apertures in the de-shedding blades 340 and the spacer tabs 362. One or more locking nuts 374a and 374b may be used to secure the de-shedding blades 340 and the spacer block 360 to a bracket, which may be attached to the handle 310.

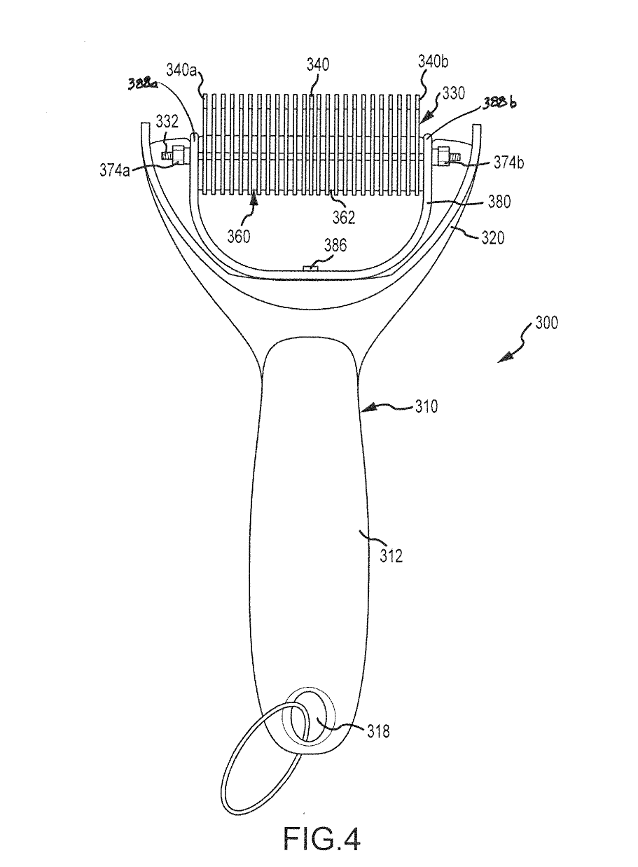

FIG. 4 illustrates a bottom view of the grooming tool 300. The grooming tool 300 includes a handle 310 that includes a gripping portion 312 that is adapted to be gripped by a user to pull the de-shedding rake 330 across the fur of an animal. The handle 310 also includes a distal aperture 318 for mounting (e.g., storage) of the grooming tool 300 and/or for receiving a lanyard. For aesthetic purposes, the handle includes a hood 320 that covers a bracket 380 and a portion of the de-shedding rake 330 when viewed from a top side of the grooming tool 300.

The de-shedding rake 330 is disposed at a distal end of the handle 310 and is attached to the handle with the bracket 380. The bracket 380 is attached to the handle 310 using a mechanical fastener 386. The de-shedding rake 330 includes a plurality of de-shedding blades 340 in spaced-apart and substantially parallel relation along an axle 332, where a longitudinal axis of the axle 332 lies substantially orthogonal to a longitudinal axis of the gripping portion 312 of the handle 310 to enable a user to manipulate the de-shedding rake 330 to groom an animal.

The de-shedding blades 340 are disposed within a spacer block 360 such that spacer tabs 362 are disposed between and separate the individual de-shedding blades 340 along a length of the axle 332. The spacer block 360 also extends beyond the plurality of de-shedding blades 340 such that the end de-shedding blades 340a and 340b are separated from the mounting arms 388a and 388b of the bracket 380. Locking nuts 374a and 374b are threaded onto the ends of the axle 332 and secure the spacer block 360 and the de-shedding blades 340 onto the axle 332.

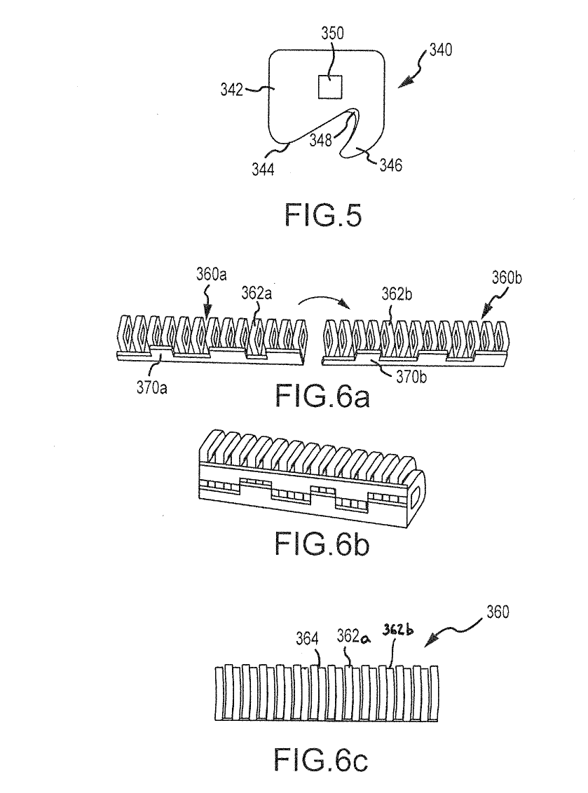

FIG. 5 illustrates a side view of a de-shedding blade 340. The de-shedding blade 340 includes a substantially planar body 342 having a bottom edge 344 and a hooked fur-engaging member 346 extending from the bottom edge 344. A sharpened curvilinear portion 348 is disposed between the bottom edge 344 and the fur-engaging member 346. The sharpened curvilinear portion 348 is generally sharper (i.e., thinner at the edge) than the other portions of the bottom edge 344 or the fur-engaging member 346. Such a structure is advantageous for removing loose fur from an animal, such as for removing the loose undercoat from a dog or for removing loose fur from a horse or other domestic animals.

FIGS. 6a-6c illustrate a perspective view of an embodiment of a spacer block 360 in accordance with the present invention. The spacer block 360 includes a first portion 360a and a second portion 360b that are illustrated separately in FIG. 6a, partially assembled in FIG. 6b and assembled in FIG. 6c. Each of the first portion 360a and the second portion 360b includes a plurality of spacer tabs 362a and 362b. The spacer tabs 362a and 362b may have substantially the same dimensions, including substantially the same width, and the width of the spacer tabs 362a and 362b is less than the width of the spaced-apart slots 364 between adjacent spacer tabs 362a and 362b when the spacer block 360 is assembled.

The first portion 360a and the second portion 360b also include interlocking members 370a and 370b that are adapted to secure the first and second portions together when they are operatively compressed together to form a unitary spacer block 360. Thus, the interlocking members 370a of the first portion 360a snap in-place between interlocking members 370b of the second portion 360b. The interlocking members 370a and 370b also serve to align the spacer tabs 362a and 362b such that when the first portion 360a and the second portion 360b are assembled, the spacer tabs 362a are disposed between the spacer tabs 362b without making contact with the spacer tabs 362b, thus forming spaced-apart slots 364 for receiving the de-shedding blades. As illustrated in FIG. 6, each portion 360a and 360b includes 13 spacer tabs, thus forming 25 spaced-apart slots 364 for receiving de-shedding blades and leaving a spacer tab 362 on each end that may be disposed between a locking nut and the end de-shedding blades.

Forming the spacer block 360 in two (or more) portions in the manner illustrated in FIG. 6 may advantageously facilitate the molding process when the spacer block 360 is fabricated from plastic, as the required width of the spaced-apart slots 364 may make the molding of a single (e.g., one-piece) spacer block difficult. In one embodiment, the width of the spacer tabs 362 is at least about 0.75 mm and not greater than about 5 mm. In this regard, the de-shedding rake may include at least about 2 de-shedding blades per centimeter, such as at least about 3 de-shedding blades per centimeter or even at least about 5 de-shedding blades per centimeter. In another embodiment, the spacing between adjacent de-shedding blades may be at least about 0.75 mm and not greater than about 5 mm, such as at least about 1 mm and not greater than about 3 mm. As such, the thickness of the spacer tabs may be at least about 0.75 mm and not greater than about 5 mm, such as at least about 1 mm and not greater than about 3 mm.

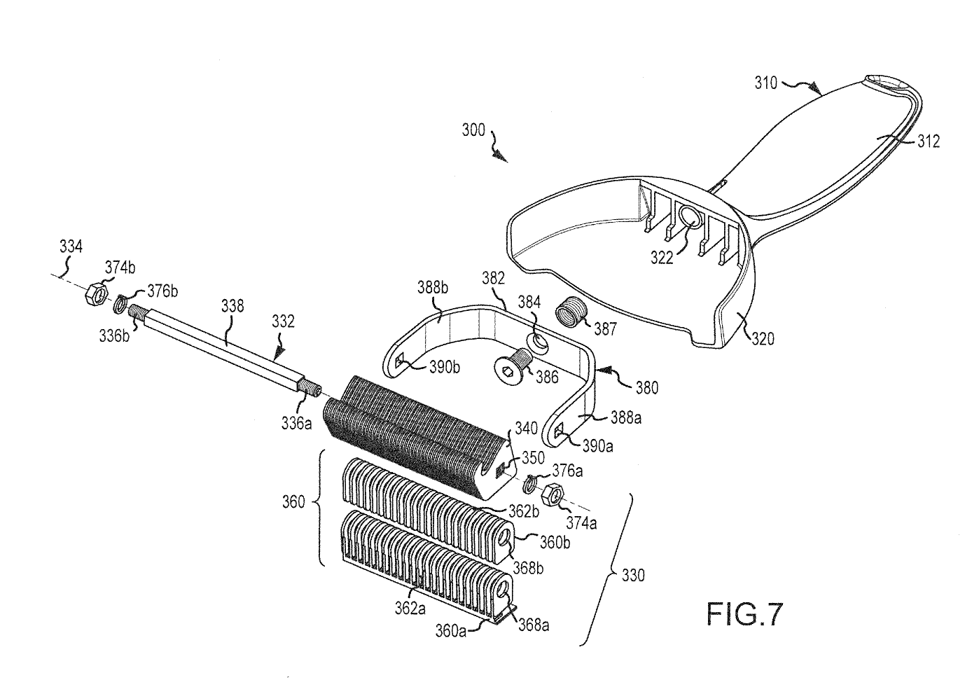

FIG. 7 illustrates an exploded view of a grooming tool 300. The grooming tool includes a handle 310 and a de-shedding rake 330 operatively attached to the handle 310 with a bracket 380. The handle includes a gripping portion 312 adapted to be gripped by a user to manipulate the de-shedding rake 330 to groom an animal and a hood 320 to cover the bracket 380 and a portion of the de-shedding rake 330 for aesthetic purposes when viewed from the top of the grooming tool 300.

The bracket 380 is attached to the handle 310 using a mechanical fastener 386 that is inserted through a fastener aperture 384 in the bracket 380 and fastened to a female threaded member 387 that is fit into a fastener receiving aperture 322 in the handle 310. Two mounting arms 388a and 388b extend from a proximal end 382 of the bracket 380. Each mounting arm 388a and 388b includes an axle end aperture 390a and 390b adapted to receive threaded end portions 336a and 336b of the axle 332 therethrough. The apertures 390a and 390b may be sized and shaped to receive ends of the main body 338 (e.g., having a non-circular cross-section) in a manner such that the axle 332 cannot rotate about its longitudinal axis 334 when so assembled. As illustrated in FIG. 7, the main body 338 of the axle 332 has a square cross-section and the apertures 390a and 390b are also square and of similar dimensions.

The de-shedding rake 330 includes a spacer block 360 having a first portion 360a and a second portion 360b that are adapted to interlock and form the spacer block 360. The first and second portions each include spacer tabs 362a and 362b having spacer tab apertures 368a and 368b therethrough for receiving the axle 332. It can be seen that it is not necessary that the spacer tab apertures 368a and 368b be shaped and sized to match the cross-section of the main body 338 of the axle 332.

A plurality of de-shedding blades 340 are provided whereby each de-shedding blade 340 may be disposed between a pair of adjacent spacer tabs 362 to maintain the desired spacing between adjacent de-shedding blades 340. Each de-shedding blade 340 includes a mounting aperture 350 that is sized and shaped to be substantially equal to the size and shape of the main body 338 of the axle 332. In this manner, the de-shedding blades can be easily aligned on the axle 332 and rotation of the de-shedding blades relative to the longitudinal axis 334 of the axle may be prevented.

After the de-shedding blades 340 are placed within the spacer block 360, the de-shedding blades 340 and the spacer block 360 may be secured to the axle by inserting the axle through aperture 390b, through apertures 368 and 350, and through aperture 390a. Thereafter, the de-shedding blades 340 and spacer block 360 may be secured using locking nuts 374a and 374b that are threaded onto threaded end portions 336a and 336b of the axle 332. Washers 376a and 376b can also be used if necessary.

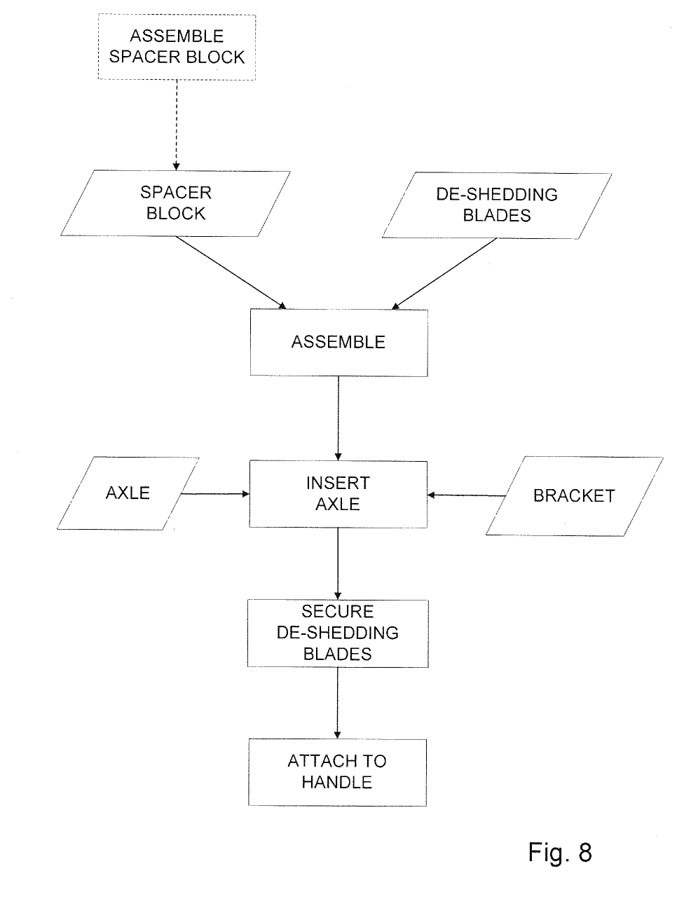

FIG. 8 is a flow sheet illustrating a method for manufacturing a de-shedding rake and a grooming tool in accordance with an embodiment of the present invention. In a first step the spacer block may be assembled if the spacer block includes two or more portions. Thereafter, the de-shedding blades and the spacer block may be assembled by placing the individual de-shedding blades within the spaced-apart slots defined by the spacer tabs of the spacer block. After the spacer block and de-shedding blades are so assembled, the axle may be inserted through the spacer block and de-shedding blades, e.g., through apertures in the de-shedding blades and spacer block. Thereafter, the de-shedding blades and spacer block may be secured to the axle by compressing the de-shedding blades and the spacer tabs together to restrict movement of the de-shedding blades, such as by using locking nuts.

The de-shedding rake may then be mounted to a handle, such as by using a bracket to operatively attach the de-shedding rake to the handle.

The use of a spacer block in accordance with the foregoing advantageously reduces the assembly time for the de-shedding rake and the grooming tool.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A grooming tool, comprising:
a handle comprising a gripping portion that is adapted to be gripped by a user;
a de-shedding rake operatively attached to the handle, the de-shedding rake comprising:
an axle having a longitudinal axis;
a spacer block disposed along the axle and comprising a plurality of spacer tabs defining spaced-apart slots along a length of the spacer block; and
a plurality of de-shedding blades operatively disposed along the axle and within the spaced-apart slots.

2. The grooming tool as recited in claim 1, further comprising a bracket operatively attaching the de-shedding rake to the handle.

3. The grooming tool as recited in claim 2, wherein the bracket is attached to the handle with a mechanical fastener.

4. The grooming tool as recited in claim 2, wherein the bracket comprises a proximal end that is affixed to the handle and two mounting arms extending from the proximal end.

5. The grooming tool as recited in claim 4, wherein the spacer block and the plurality of de-shedding blades are mounted between the two mounting arms extending away from the proximal end.

6. The grooming tool as recited in claim 1, wherein a cross-section of the axle orthogonal to the longitudinal axis is non-circular.

7. The grooming tool as recited in claim 1, wherein a cross-section of the axle orthogonal to the longitudinal axis is substantially rectangular in cross-section.

8. The grooming tool as recited in claim 1, wherein the de-shedding blades comprise a substantially planar body that is mounted substantially orthogonally to the longitudinal axis of the axle.

9. The grooming tool as recited in claim 8, wherein the substantially planar body comprises a bottom edge and a fur-engaging member extending from the bottom edge.

10. The grooming tool as recited in claim 9, wherein the substantially planar body further comprises a sharpened curvilinear portion between the bottom edge and the hooked fur-engaging member.

11. The grooming tool as recited in claim 8, wherein the de-shedding blades comprise a corrosion-resistant metal.

12. The grooming tool as recited in claim 1, wherein the spacer block comprises plastic.

13. The grooming tool as recited in claim 12, wherein the spacer block comprises first spacer block portion comprising first spacer tabs and a second spacer block portion comprising second spacer tabs, where the first and second portions are fastened together such that the first spacer tabs are disposed between the second spacer tabs.

14. The grooming tool as recited in claim 1, further comprising a locking nut threaded onto at least one end of the axle to secure the de-shedding blades and the spacer block onto the axle.

15. The grooming tool as recited in claim 14, wherein the locking nut compresses the de-shedding blades and the spacer tabs together.

16. The grooming tool as recited in claim 1, wherein the de-shedding rake comprises at least about 10 de-shedding blades per inch along the longitudinal axis of the axle.

17. A grooming tool, comprising:
a handle comprising a gripping portion that is adapted to be gripped by a user;
a de-shedding rake, the de-shedding rake comprising:
an axle having a longitudinal axis wherein a cross-section of the axle orthogonal to the longitudinal axis is non-circular;
a plastic spacer block disposed along the axle and comprising a plurality of spacer tabs defining spaced-apart slots along a length of the spacer block;
a plurality of de-shedding blades operatively disposed along the axle and within the spaced-apart slots; and
at least a first locking nut threaded onto an end of the axle to secure the de-shedding blades and the spacer block onto the axle and compress the de-shedding blades and the spacer tabs together; and
a bracket operatively attaching the de-shedding rake to the handle, the bracket comprising a proximal end that is affixed to the handle and two mounting arms extending from the proximal end, wherein the de-shedding blades and plastic spacer block are disposed between the two mounting arms of the bracket.

18. A method for manufacturing a de-shedding rake portion of a grooming tool, comprising the steps of:
placing a plurality of de-shedding blades within spaced-apart slots defined by a plurality of spacer tabs of a plastic spacer block;
inserting an axle having a longitudinal axis through mounting apertures disposed in the de-shedding blades and through spacer block apertures disposed in the spacer tabs; and
securing the de-shedding blades and the spacer block onto the axle by fixedly compressing the de-shedding blades and the spacer tabs together to restrict movement of the de-shedding blades along the longitudinal axis.

19. The method for manufacturing a de-shedding rake as recited in claim 18, further comprising the step of assembling the plastic spacer block by fastening together a first spacer block portion having first spacer tabs and a second spacer block portion having second spacer tabs such that the first spacer tabs are disposed between the second spacer tabs.

20. The method for manufacturing a de-shedding rake as recited in claim 18, further comprising the step of attaching the axle to spaced-apart mounting arms of a bracket.

21. A method for manufacturing a grooming tool, comprising the steps of:
manufacturing a de-shedding rake portion by the method of claim 18; and
attaching the de-shedding rake portion to a handle comprising a gripping portion that is adapted to be gripped by a user.
